(19) United States
(12) Patent Application Publication
(10) Pub. No.: US 2018/0208076 A1
(43) Pub. Date: Jul. 26, 2018

(54) AUTO-BALANCING VEHICLE WITH POWER BASED SITUATIONAL OPERATING LIMITS

(71) Applicant: Shane Chen, Camas, WA (US)

(72) Inventor: Shane Chen, Camas, WA (US)

(21) Appl. No.: 15/880,511

(22) Filed: Jan. 25, 2018

Related U.S. Application Data
(60) Provisional application No. 62/450,566, filed on Jan. 25, 2017.

(51) Int. Cl. B60L 15/20; B62K 11/00

(52) U.S. Cl. CPC B60L 15/20; B62K 2015/003; B60L 2200/16; B62K 11/007

(57) ABSTRACT

Control for an auto-balancing transportation device and the transportation devices having such controls. The controls monitoring system power and power use and generating a corrective response when the difference between system (or device or available) power and power use is below a given threshold. Power use may be calculated using a velocity parameter which provides a measure that more accurately reflects the environment conditions in which the device is being use, and provides benefits over a one-speed speed limit. Various corrective responses including pitch back and alarms, including those to a user-borne device are disclosed.

### CROSS REFERENCE TO RELATED APPLICATIONS

This application claims the benefit of U.S. Provisional Application No. 62/450,566, filed Jan. 25, 2017, entitled Self-Balancing Vehicle with Power Based Situational Operating Limits and having the same inventor as above.

### FIELD OF THE INVENTION

The present invention relates to a fore-aft self-balancing transportation devices and, more specifically, to utilizing power to establish appropriate operating limits for such devices.

### BACKGROUND OF THE INVENTION

The prior art includes the Solowheel and Hovertrak personal transportation devices developed by Shane Chen, the inventor herein, and described in U.S. Pat. Nos. 8,807,250 and 8,738,278, respectively. The prior art also includes devices from Segwey developed by Kamen et al and described in U.S. Pat. Nos. 6,302,230 and 9,188,984, among others. The '230 patent discloses features of a basic Segwey device while the '984 patent discloses a singular “speed limit” for such a device. These four patents (the '250, '278, '230 and '984) are hereby incorporated by reference as though described herein.

When the device of the '984 patent exceeds its speed limit, a “pitch back” is performed. Pitch back is a tilting of the platform backward, in this instance to give notice to a rider that the speed limit has been reached. It may also cause a rider to reduce forward lean. The pitch back is maintained until device speed drops below the “speed limit.” This pitch back operation is found in several prior art devices.

The speed control device of the '984 patent is disadvantageous because (1) there is effectively one fixed speed limit and (2) there is no correction or alert for over-acceleration at low speeds, among other disadvantages. The '984 patent states, at col. 17, lines 47-49, “Speed limiting occurs whenever the vehicle velocity of the vehicle exceeds a threshold that is the determined speed limit of the vehicle.” It further states, at cols. 17-18, lines 66-2, that a “method for determining the speed limit of the vehicle is to monitor the battery voltage . . . to estimate the maximum velocity the vehicle is currently capable of maintaining.” Since the battery voltage is substantially constant (except at end of charge), this “speed limit” is effectively a constant, one-speed limit.

Speed alone, however, does not correlate directly to the vehicle's ability to sustain balancing operation. A truer measure of balancing ability is the amount of power available versus the power needed, which is significantly influenced by environmental factors such as slope, weight of rider, roughness of riding surface, wind/air resistance, etc., and acceleration rate.

Regarding these environmental factors, a heavier rider will necessitate more power consumption as will going uphill, into the wind or over a rough surface. The converse is true for a lighter rider, downward slope, smooth surface, etc. The “single” speed limit of the prior art does not account for the impact of these factors.

With respect to acceleration rates, the majority of “over-acceleration” accidents tend to happen at low speed, yet the single speed limit device fails to account for these situations.

The '984 patent, at col. 17, lines 52-60, also discloses a “balancing margin between a specified maximum power output and the current power output of the motors.” If the margin falls below a specified limit, “an alarm may be generated to warn the user to reduce the speed of the vehicle.” The '984 patent does not teach pitching back the platform in response to a low balancing margin, but merely issuing a warning, audible, visual or tactile (such as a vibration). The '984 patent teaches pitch back only when the “speed limit” is surpassed.

It should be recognized that the “balancing margin” of the '984 patent was never implemented in a product. The speed limit, however, was implemented. Further, the '984 patent is silent on how power for the balancing margin is calculated. Col. 18, lines 2-6, discuss measuring “the voltages of the battery and the motor” and monitoring “the difference between the two” to estimate the balancing margin. Voltage, however, is only one component of power. There is no mention of how power is actually calculated. There is only a statement that power may be “estimated” by a voltage measure. Thus, since the “balancing margin” was never implemented and the parameters or method of calculating it are not described, a power-based balancing margin is not actually disclosed in the '984 patent or the products described therein.

In view of the prior art, there is a need for a self-balancing vehicle that takes into consideration environmental factors (including rider weight) in establishing operational limits. There is also a need for a self-balancing vehicle that addresses “over-acceleration” events at low speed. Furthermore, there is a need for self-balancing a vehicle that establishes appropriate vehicle operating limits based on power, rather than a one size fits all “speed limit.”

### BRIEF DESCRIPTION OF THE DRAWINGS

FIGS. 1-4 are perspective views of the Solowheel, Hovertrak, Segwey, and Iota personal transportation devices in which the situational control of the present invention may be implemented.

FIG. 5 illustrates two inter-related graphs that maximum speed variations based on situational conditions.

FIG. 6 is a block diagram of one embodiment of internal control and sensing components for auto-balancing transportation devices in accordance with the present invention.

### DETAILED DESCRIPTION

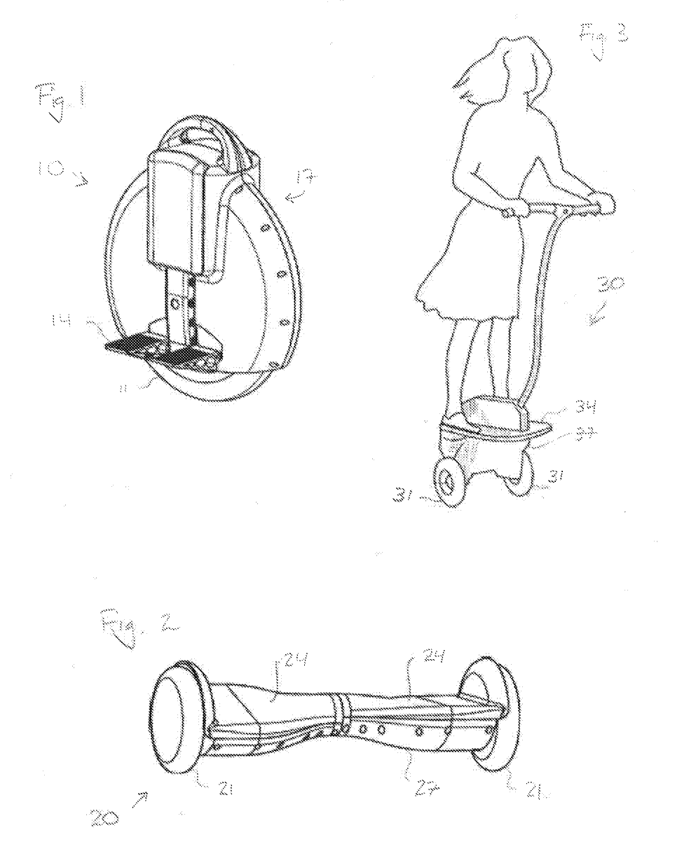

Referring to FIGS. 1-4, perspective views of the Solowheel, Hovertrak, Segwey, and Iota personal transportation devices 10,20,30,40 respectively, are shown. FIGS. 1-3 are from the '250, '278 and '230 patents, respectively. Each of these devices includes one or more wheels or wheel structures 11,21,31,41, and one or more foot platforms 14,24,34,44. They also include a drive motor, battery, electronic control circuitry, and position sensor (these components being internal to housing 17,27,37,47). The Segway may have a handlebar 38 and/or another mechanism for user interfacing and control, while the Solowheel, Hovertrak and Iota are “foot-controlled” devices, controlled primarily by the ball and heel of a user's foot. The operation of and components for these and like devices are generally known in the art. In should be noted that the terms “vehicle” and “device” (when referring to a vehicle) may be used interchangeably herein, as vehicles are a type of device.

These four devices 10,20,30,40 are presented here because the power based control of the present invention may be implemented in them, and in other self-balancing devices. This power based control involves monitoring power use to create situation based operating limits.

### Situational Use

The higher the speed of the vehicle, the more power required to overcome rolling resistance and air resistance, and the less power available for acceleration (whether that is user desired acceleration or auto-balancing required acceleration). Thus, a rider accelerating from a standstill will notice that as their speed increases, the maximum allowed vehicle acceleration decreases.

Assuming, for example, a rider continues accelerating at the maximum allowed rate at every moment while all environmental conditions remain constant, then the rate of acceleration will decrease until the final pitch back point is reached. The speed at which this happens is the situational maximum speed because the device is not able to go faster.

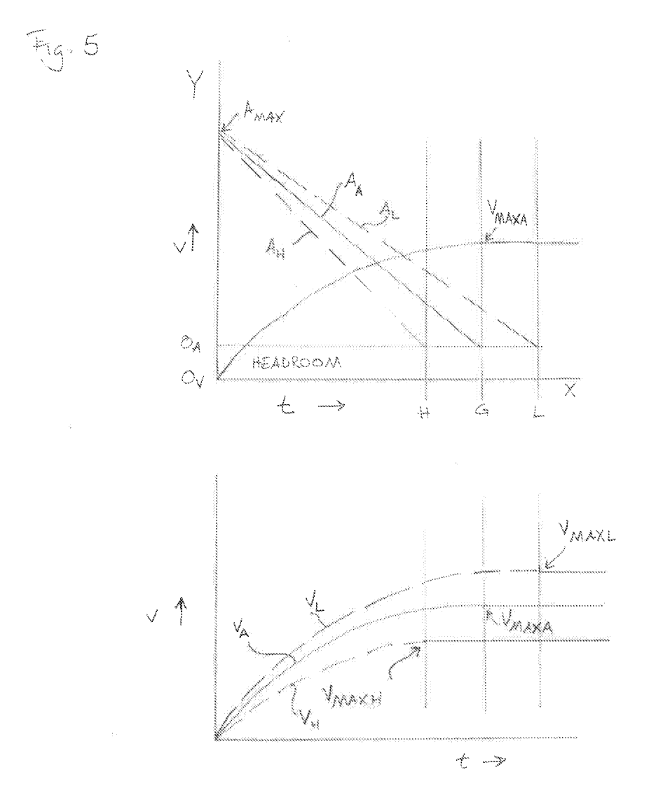

Referring to FIG. 5, two inter-related graphs are shown that illustrate this principle. The Y-axis in both graphs represents magnitude. Starting from a standstill, a vehicle quickly achieves maximum acceleration (Aₘₐₓ) which is indicated by the upper left end of line A_{A}. Note that the gap between 0 acceleration (0_{A}) and 0 velocity (0_{V}) is the “head room.” Head room is essentially a power reserve to provide sufficient acceleration at V to achieve pitch back.

The top graph indicates acceleration for a given rider on a relatively smooth surface. From A_{MAX}, acceleration steadily declines due to rolling and air resistance as described above until it reaches zero which is the point of maximum velocity, Vₘₐₓ. This rate of acceleration is represented by line A_{A}, for acceleration of an “average” weight rider. It is shown as a straight line for pedagogic purposes but in may not be wholly linear.

Assuming all factors stay the same and a heavier rider steps on the vehicle, then more power will be required to overcome rolling and air resistance and less will be available for acceleration. Thus, the rate of acceleration A_{H} (“H” for heavier) and the maximum velocity, V_{MAXH}, will decrease. Conversely, if a lighter rider steps on the vehicle, there will be more power available for acceleration yielding increased acceleration A_{L} (“L” for lighter) and a higher V_{MAXL}.

Furthermore, if there is an uphill slope, then lines AH, AL will shift to the left and if a downward slope, to the right. Similar shifts may occur is there is significant wind or a rough riding surface, etc., and these factors may be cumulative, resulting in a significant variation in acceleration rate and maximum velocity.

The lower graph represents velocity. Velocity of the “average” rider, V_{A}, is the middle line. V_{H} and V_{L} are below and above V_{A}, respectively, and may increase or decrease due to the factors discussed here. V_{MAX} is indicated for the heavy, average and light rider. Given the additive effect of these factors, V_{MAX} can be lower or higher than shown.

To address the conditions described above (and related conditions), operating limits, including situational maximum velocity, may be established based on available power, power use, and current vehicle speed. For example, high vehicle speed and low power use may mean there is a lightweight rider or a downward slope, or both. In this situation, a rider can go faster because there is plenty of power available for self-balancing and pitch back, even at the higher speed. However, high vehicle speed and high power use may mean the device has reached its maximum speed and thus a corrective measure should soon be taken. Furthermore, low speed and high power use may mean a hill or heavy rider (or both, or low battery, etc.) and the maximum speed may have been reached even if at low speed.

Table I below illustrates conditions that may be monitored, directly or indirectly. Quadrants A and C illustrate situations in which low power use (relative to available power) is sensed. Whether at high or low speed, these situations are relatively benign operationally because there is sufficient power to self-balance and pitch back. In quadrant B and D, power use is high, relative to available power.

TABLE I
Power and Speed Conditions

| A. | B. |
|---|---|
| low power use | high power use |
| low speed | low speed |
| C. | D. |
| low power use | high power use |
| high speed | high speed |

Quadrant B indicates at least two situations. One is the high resistance scenario—heavy rider, going uphill, rough surface, wind, etc. The maximum allowable velocity here will be low because with high power use, there is little available power left to drive the device faster. Another situation is over-acceleration at low speed. The over-acceleration causes high power use to try to catch up. In prior art devices, corrective action may not be taken because the single speed limit has not yet been reached and the rider may fall. In the present invention, the sensing of high power use permits a corrective action such as pitch back (or other action) to reduce the possibility of a rider fall, even when device speed is low.

Similarly, a low battery could create a condition of high power use relative to available power and thus could reduce the maximum allowable velocity or acceleration accordingly.

### Monitoring and Feedback

The maximum output power, P_{MAX}, is based on the measured battery energy level and is the potential maximum output power of the system (i.e., device). As the battery power is reduced, the maximum output power is reduced, though the curve of this relationship is fixed.

At any given moment, the instantaneous power use of device (10,20,30,40), P, may be calculated. It may also be averaged over time to minimize spikes. Subtracting this instantaneous power from P yields the power left to perform work (which may be increasing or maintaining vehicle speed, performing a pitch back, or other). When the value, A, of P_{MAX}−P falls below a certain value, then pitch back and/or another corrective action may be taken. In addition, it may be that two or more “response ranges” are defined for A, for example, a first, less critical range in which an alarm is generated and a second, more critical range in which an action (involuntary to the rider) such as pitch back is taken.

The power parameters and their relationship may be expressed as in Equation 1 below.

$$A = {P}_{max} - \frac{{\sum }_{i = 1}^{n} p}{n} \qquad ( 1 )$$

If P instantaneous is measured as the power draw at the battery P_{battery}, then Equation 1 may be written as:

A=Pₘₐₓ−P_{battery}=Pₘₐₓ−(V_{battery}*I_{battery}) (2)

The output power of the battery, however, does not equal the output power of the motor and this electric energy loss cannot be ignored. Thus, a more accurate representation is A=Pₘₐₓ−Pₘₒₜₒᵣ. The power at the motor, however, can be represented by the work per unit time, force×velocity, performed by the motor. This yields Equation 3. This velocity parameter is a mechanical parameter (as opposed to an electrical measure such at voltage or current).

A=Pₘₐₓ−Pₘₒₜₒᵣ=Pₘₐₓ−(Fₘₒₜₒᵣ*V) (3)

The Fₘₒₜₒᵣ can in turn be calculated from torque (M) and the arm of force (r), effectively the radius, to yield

$$A = {P}_{max} - \frac{{\sum }_{i = 1}^{n} p}{n} = {P}_{max} - \frac{{\sum }_{i = 1}^{n} F \cdot v}{n} = {P}_{max} - \frac{{\sum }_{i = 1}^{n} M \cdot v}{n \cdot r} \qquad ( 4 )$$

Torque in turn may be calculated from the current of the motor (M=cal*I, where cal is a current-force coefficient) as is known.

This achieves a determination of power based on mechanical operation and incorporates a velocity measure which is a more accurate indication of device performance and limits. Furthermore, the equation permits a determination of the appropriate condition(s) at which to issue an alarm or perform pitch back, etc., based on environmental conditions, rider size, available power, etc.

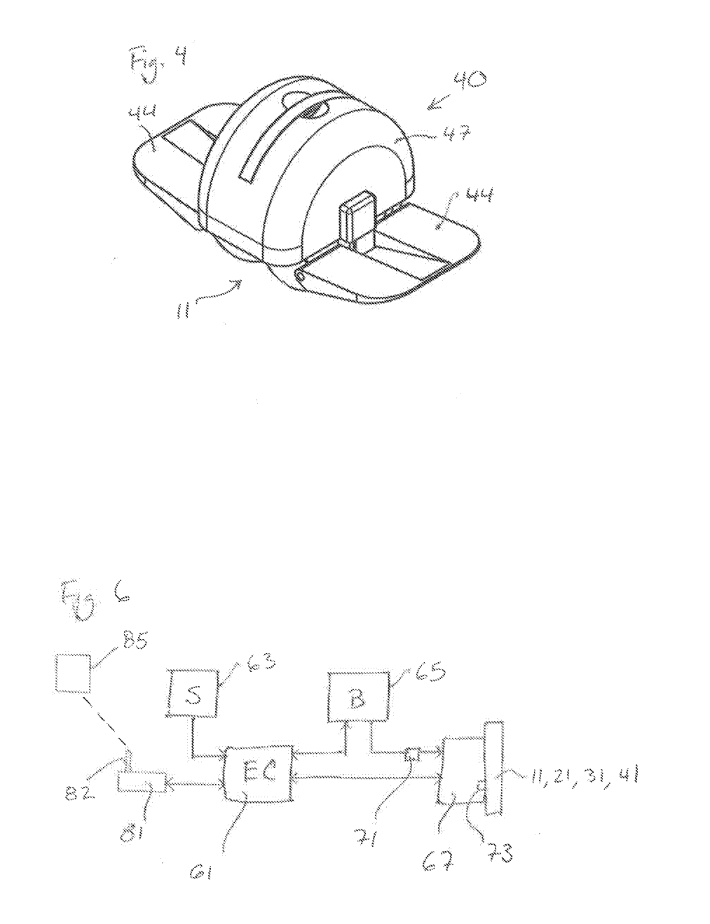

Referring to FIG. 6, a block diagram of one embodiment of internal control and sensing components for devices 10,20,30,40 in accordance with the present invention is shown. These devices preferably include an electronic controller 61 and gyroscopic (or other suitable fore-aft position) sensor 63, battery 65, drive motor 67, wheel 11,21,31 or wheel structure 41, a current sensor 71 and a velocity sensor 73.

Sensor 71 may be a circuit board mounted sensor that measures current at battery 65 and sensor 73 may be a Hall effect sensor or other suitable sensor used to determine velocity. Current and velocity measurements are propagated to electronic control circuit 61 for processing in the equations discussed herein.

While control/drive components for only one wheel/wheel structure are shown in FIG. 6, additional components may be provided for multi-wheel devices such as devices 20 and 30, as is known. With two relatively movable foot platforms, device 20 preferably has a position sensor for each foot platform.

FIG. 6 also illustrates a wireless antenna assembly 81 with an antenna 82. Electronic controller 61 and the antenna assembly 81 are preferably configured to communicate with a mobile phone or wearable device (or other user-borne communication device) 85. The wearable device may be a smart watch or fitness/activity/gps monitor or other device. Warnings, diagnostics, battery levels, speed, distance, and other information can be communicated between the vehicle and a rider via these types of user borne communication devices. With respect to the communication of information to the user-borne device, this information may include a visual display of speed, or an audio indication (a tone that equates to a given speed or number of beeps or a voice at a given speed, or other audio indicators). Device 10,20,30,40 may also be configured to provide “warnings” to a rider and these may be manifested visually (lights or a screen or other), by audio, by feel (vibrations) or other. These warnings may be generated in the first less critical response range described above.

The antenna assembly and electronic controller may also be configured such that the device receives input from a user via the user-borne communication device 85.

The present invention includes monitoring available power and generating a corrective action (such as pitch back or the like) and/or communicating in some other manner that the available power is at a critically low level. Furthermore, the present invention includes generating various “warning” that may be delivered by audio, visual, tactile or other sensory pathways. For purposes of the present invention, an action, such as pitch back or the like, is an automatic act or function (i.e., involuntary from the perspective of a user) that affects operation of the device (often mechanically or electrically) and is not necessarily intended to communicate to the rider, but rather impact performance. An action may or may not be noticed by the rider. For example, pitch back happens automatically and a rider may not even notice. A warning or alarm, on the other hand, is intended to draw the attention of the rider. The rider may then decide to take a “voluntary” action, such as slowing down (leaning back), etc.

Generally, while actions may be manifested directly in device 10,20,30,40, warnings may be realized in the device and/or the rider-borne communication device 85. Actions, warnings, alarms, etc., may be generally be referred to collectively as “responses” or “corrective responses.”

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. An auto-balancing transportation device, comprising:
a platform;
a wheel coupled to the platform and a drive motor that drives the wheel;
a sensor associated with the platform; and
a control circuit, coupled to the drive motor and the sensor, that generates control signals to the drive motor to drive the wheel towards auto-balancing the device;
wherein the device is configured to determine power use using a velocity parameter.

2. The device of claim 1, wherein the device is configured to generate a response when the determined power use exceeds a threshold.

3. The device of claim 1, wherein the device is configured to determine a system power and to monitor the difference between a system power and power use, and further to generate the response based on the difference between the system power and the power use.

4. The device of claim 1, further comprising a current sensor and a velocity associated sensor that are coupled to the control circuit and the control circuit is configured to determine power use using a current parameter from the current sensor and the velocity parameter; and
wherein the velocity parameter is determined at least in part from data from the velocity associated sensor.

5. The device of claim 1, wherein the response includes at least one of an action and an alarm.

6. The device of claim 1, wherein the response is pitch back of the platform.

7. The device of claim 1, wherein the response include wireless signal propagation to a user-borne device.

8. The device of claim 1, wherein the sensor is a position sensor capable of sensing fore-aft pitch position.

9. The device of claim 1, further comprising a current sensor that senses current at the motor.

10. The device of claim 1, wherein the velocity parameter includes a measure of torque exerted by the motor.

11. An auto-balancing transportation device, comprising:
a platform;
a wheel coupled to the platform and a drive motor that drives the wheel;
a sensor associated with the platform;
a control circuit, coupled to the drive motor and the sensor, that generates control signals to the drive motor to auto-balancing the device;
wherein the control circuit is configured to determine power use using a mechanical parameter.

12. The device of claim 11, wherein the mechanical parameter is a velocity parameter.

13. The device of claim 12, further comprising a current sensor and a velocity associated sensor that are coupled to the control circuit and the control circuit is configured to determine power use using a current parameter from the current sensor and the velocity parameter; and
wherein the velocity parameter is determined at least in part from data from the velocity associated sensor.

14. The device of claim 11, wherein the response includes at least one of an action and an alarm.

15. The device of claim 11, wherein the response is pitch back of the platform.

16. The device of claim 12, further comprising a current sensor that senses current at the motor and wherein the velocity parameter includes a measure of torque exerted by the motor.

17. An auto-balancing transportation device, comprising:
a platform;
a wheel coupled to the platform and a drive motor that drives the wheel;
a sensor associated with the platform;
a control circuit, coupled to the drive motor and the sensor, that generates control signals to the drive motor to auto-balancing the device;
wherein the control circuit is configured to monitor power use and to generate a pitch back of the platform when power use exceeds a threshold relative to device power.

18. The device of claim 17, wherein the sensor is a position sensor capable of sensing a fore-aft pitch position of the platform, and further comprising:
a current sensor that senses current at the motor and a velocity associated sensor, both coupled to the control circuit; and
wherein the control circuit determines power use based, at least in part, on data from the current sensor and the velocity associated sensor.

19. A method for generating a corrective response in an auto-balancing device that includes a platform, a wheel coupled, a motor that drives the wheel, a sensor associated with the platform, and a control circuit that generates control signals to the motor to drive the wheel towards auto-balancing the device, comprising the steps of:
determining power use using a velocity parameter; and
generating a corrective response when the power use exceeds a threshold.

20. The method of claim 19, wherein the generating step includes generating the corrective response when the power use exceeds a threshold relative to device power.

21. The method of claim 19, wherein the generating step includes generating a pitch back of the platform when the power use exceeds a threshold.
